(19) United States
(12) Patent Application Publication
(10) Pub. No.: US 2026/0351435 A1
(43) Pub. Date: Nov. 5, 2026

(54) REACTOR FACILITY

(71) Applicant: KOREA ATOMIC ENERGY RESEARCH INSTITUTE, Daejeon (KR)

(72) Inventors: Hyunjun CHO, Daejeon (KR); Soo Jai SHIN, Daejeon (KR); Kwanghyun AHN, Daejeon (KR); Youngmin BAE, Daejeon (KR); Minkyu LEE, Daejeon (KR); June-woo KEE, Daejeon (KR)

(21) Appl. No.: 19/662,290

(22) Filed: Apr. 29, 2026

(30) Foreign Application Priority Data
Apr. 30, 2025 (KR) 10-2025-0057209

(51) Int. Cl. G21D 3/00; G21C 13/028; G21C 15/12; G21C 15/20; G21C 15/243; G21C 15/253; G21D 1/00

(52) U.S. Cl. CPC G21D 3/007; G21C 13/0285; G21C 15/12; G21C 15/20; G21C 15/243; G21C 15/253; G21D 1/006

(57) ABSTRACT

According to an aspect of the present disclosure, a nuclear reactor facility includes a pressure vessel; a pool providing pool water in which the pressure vessel is submerged; a partition unit disposed inside the pool to provide an inner space in which the pressure vessel is accommodated; a heat exchanger disposed in the inner space of the partition unit and outside the pressure vessel to transfer heat from the pressure vessel to the pool water of the pool; and a pressure control unit configured to increase a pressure of the inner space of the partition unit so that a water level of the pool water inside the partition unit is lowered down to a level lower than at least a portion of the heat exchanger.

### CROSS-REFERENCE TO RELATED APPLICATION

The present application claims the benefit of priority to Korean Patent Application No. 10-2025-0057209, filed on Apr. 30, 2025 in the Korean Intellectual Property Office. The aforementioned application is hereby incorporated by reference in its entirety.

### TECHNICAL FIELD

The present disclosure relates to a nuclear reactor facility.

### BACKGROUND OF THE INVENTION

A nuclear reactor facility may include a pool and a nuclear reactor submerged in the pool. The nuclear reactor may include a pressure vessel accommodating a core, a steam generator generating steam, and a heat exchanger condensing the steam. The nuclear reactor may transfer heat to the pool for cooling. Specifically, steam generated from the steam generator may flow through a pipe to the heat exchanger submerged in the pool, and may be condensed while exchanging heat with water of the pool in the heat exchanger.

Because a large amount of water present in the pool during normal operation of the nuclear reactor, the pool is not depleted within a short period of time and continuously performs as a heat sink even when sensible heat and decay heat are continuously transferred to the pool of the nuclear reactor after an accident. Even without operator action or emergency power, the nuclear reactor may maintain a water level of the water of the pool higher than an upper end of the heat exchanger for at least 72 hours after an accident.

However, such a design has a drawback in that inspection and maintenance of an outer wall of the nuclear reactor, the heat exchanger, and the like are very difficult, since the nuclear reactor is submerged in water to a large extent. When only a single nuclear reactor is present inside a reactor building, maintenance may be facilitated by lowering a water level of the pool by draining water from the pool during shutdown and maintenance of the nuclear reactor. However, when a plurality of nuclear reactors are operated simultaneously, inspection and maintenance must be performed on a specific nuclear reactor while the remaining modules are in normal operation. In this case, lowering the water level of the pool reduces an accident response capability of the remaining modules, making it difficult to adopt a method of collectively lowering the water level of the pool of the nuclear reactor. Consequently, in order to perform inspection and maintenance while maintaining the water level of the pool, underwater inspection and maintenance, such as diving or the like, need to be performed, which leads to operational difficulties and increased costs.

### SUMMARY OF THE INVENTION

An object of the present disclosure is to provide a nuclear reactor facility capable of lowering a water level of a pool in an inner space of a partition unit accommodating a nuclear reactor in shutdown state of the nuclear reactor.

A nuclear reactor facility to an aspect of the present disclosure includes a pressure vessel; a pool providing pool water in which the pressure vessel is submerged; a partition unit disposed inside the pool to provide an inner space in which the pressure vessel is accommodated; a heat exchanger disposed in the inner space of the partition unit and outside the pressure vessel to transfer heat from the pressure vessel to the pool water of the pool; and a pressure control unit configured to increase a pressure of the inner space of the partition unit so that a water level of the pool water inside the partition unit is lowered down to a level lower than at least a portion of the heat exchanger

According to an embodiment of the present disclosure, the heat exchanger may be easily inspected or maintained, since the water level of the pool water in the inner space of the partition unit may be lowered by the pressure control unit.

Furthermore, inspection and maintenance of a piping unit and a penetrating portion of the pressure vessel penetrated by the piping unit are facilitated due to the lowered water level of the pool water.

Furthermore, only the water level of the pool water in the inner space of the partition unit accommodating the nuclear reactor requiring maintenance can be lowered, while the water level of the pool water outside the partition unit is maintained.

Furthermore, it is possible to easily determine, from outside the partition unit, whether the water level of the pool water in the inner space of the partition unit has reached a target water level, by means of a partition wall hole.

### BRIEF DESCRIPTION OF THE DRAWINGS

FIG. 1 is a view illustrating a nuclear reactor facility according to a first embodiment of the present disclosure.

FIG. 2 is a view illustrating a state in which a water level of pool water in an inner space of a partition unit of the nuclear reactor facility of FIG. 1 is lowered.

FIGS. 3A, 3B and 3C are views illustrating a sealing unit of a nuclear reactor facility according to a second embodiment of the present disclosure.

FIG. 4 is a view illustrating a nuclear reactor facility according to a third embodiment of the present disclosure.

FIG. 5 is a view illustrating a nuclear reactor facility according to a fourth embodiment of the present disclosure.

FIG. 6 is a view illustrating a nuclear reactor facility according to a fifth embodiment of the present disclosure.

FIG. 7 is a view illustrating a state in which a water level of pool water in an accommodation space of an accommodating part of the nuclear reactor facility of FIG. 6 is lowered.

FIG. 8 is a cross-sectional view of the nuclear reactor facility of FIG. 7 taken along line Ⅷ-Ⅷ.

FIG. 9 is a view illustrating the accommodating part of the nuclear reactor facility of FIG. 6 as viewed from above.

### DETAILED DESCRIPTION OF THE INVENTION

Hereinafter, exemplary embodiments for implementing the technical spirit of the present disclosure will be described in detail with reference to the drawings.

In addition, in describing the present disclosure, detailed descriptions of related known configurations or functions will be omitted when determined to obscure the gist of the present disclosure.

Furthermore, when a certain component is referred to as being 'supported by', 'connected to', or 'in contact with' another component, the certain component should be understood to be directly supported by, connected to, or in contact with the other component, but another component may be present in the middle.

The terms used in the present specification are merely used to describe specific embodiments and are not intended to be used to limit the present disclosure. A singular expression includes a plural expression unless clearly meaning otherwise in context.

Furthermore, expressions such as upper side, lower side, and side surface in the present specification are described based on the illustration in the drawings, and may be expressed differently when a direction of a corresponding object is changed. For the same reason, some components are exaggerated, omitted, or schematically illustrated in the accompanying drawings, and a size of each component does not entirely reflect an actual size.

Furthermore, terms including ordinal numbers such as first and second may be used to describe various components, but the components are not limited by the terms. These terms are used only for the purpose of distinguishing one component from another component.

The meaning of "including" used in the specification specifies a specific characteristic, region, integer, operation, action, element, and/or component, and does not exclude the presence or addition of other specific characteristics, regions, integers, operations, actions, elements, components, and/or groups.

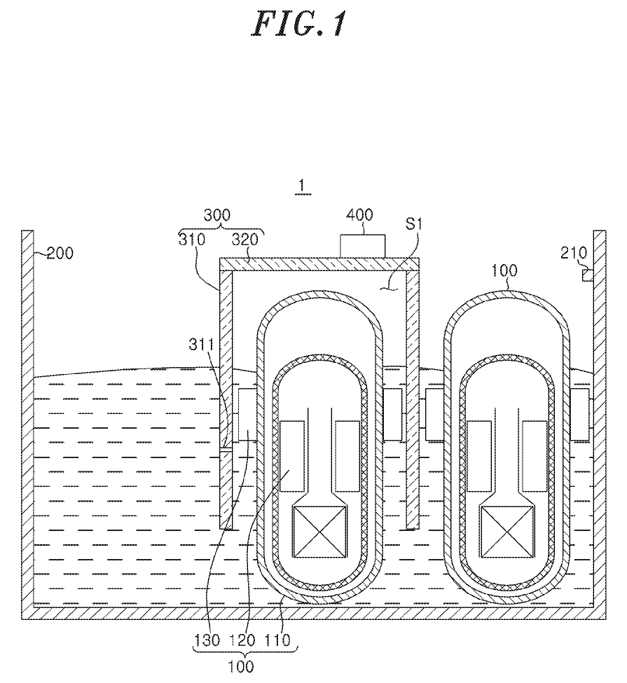

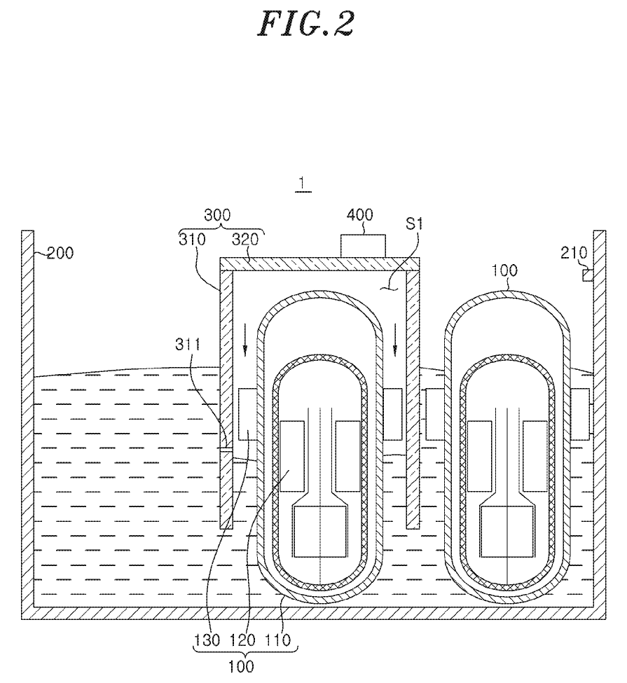

Hereinafter, a nuclear reactor facility 1 according to a first embodiment of the present disclosure will be described with reference to FIGS. 1 and 2.

The nuclear reactor facility 1 according to the first embodiment of the present disclosure may generate steam for operating a turbine, a ship, a facility, or the like. The nuclear reactor facility 1 may be installed on land, but is not limited thereto, and may be loaded on mobile equipment such as a ship or a vehicle. The nuclear reactor facility 1 may include a nuclear reactor 100, a pool 200, a partition unit 300, and a pressure control unit 400.

The nuclear reactor 100 may generate steam. The nuclear reactor 100 may be submerged in the pool 200. Furthermore, a plurality of nuclear reactors 100 may be provided. The nuclear reactor 100 may include a pressure vessel 110, a steam generator 120, and a heat exchanger 130.

The pressure vessel 110 may accommodate a core for nuclear fission. Furthermore, the steam generator 120 may be disposed inside the pressure vessel 110. The pressure vessel 110 may be accommodated inside the partition unit 300. The pressure vessel 110 may be a pressure vessel made of a metallic material. The pressure vessel 110 may include at least one of a containment vessel and a reactor vessel.

The steam generator 120 may generate steam by heat of the pressure vessel 110. The steam generator 120 may be disposed inside the pressure vessel 110. Under a normal operating condition of the nuclear reactor 100, steam generated from the steam generator 120 may be supplied to a turbine(not shown) or the like. In the event of an accident of the nuclear reactor 100, the steam generated from the steam generator 120 may be supplied to the heat exchanger 130 to be cooled to cool the core.

The heat exchanger 130 may cool the steam generated from the steam generator 120 using the pool water of the pool 200. The heat exchanger 130 may be disposed outside the pressure vessel 110. Furthermore, the heat exchanger 130 may be disposed in an inner space of the partition unit 300. The heat exchanger 130 may be disposed at a position higher than the steam generator 120. Furthermore, the heat exchanger 130 may be disposed at a position higher than a partition wall hole 311 of the partition unit 300 described later.

The pool 200 may provide pool water in which a plurality of nuclear reactors 100 are submerged. A water level of the pool water of the pool 200 may be disposed above the heat exchanger 130. Furthermore, a support part 210 may be provided in the pool 200. The support part 210 may protrude from an inner surface of the pool 200 to support a partition wall cover 320 described later.

The partition unit 300 may provide an inner space S1 for accommodating the nuclear reactor 100. A lower side of the partition unit 300 may be disposed to be spaced apart from a bottom surface of the pool 200. In other words, the pool water may flow into the inner space S1 of the partition unit 300. A water level of the pool water in the inner space S1 of the partition unit 300 may be equal to a water level of the pool 200. The partition unit 300 may accommodate at least one of the plurality of nuclear reactors 100, but is not limited thereto. In other words, a plurality of partition units 300 may be provided to respectively accommodate each of the plurality of nuclear reactors 100. The partition unit 300 may include a partition wall 310 and a partition wall cover 320.

The partition wall 310 may be disposed inside the pool 200, and provide an inner space S1 in which the nuclear reactor 100 is accommodated. Openings may be formed at an upper side and a lower side of the partition wall 310. Furthermore, the lower side of the partition wall 310 may be spaced apart from the bottom surface of the pool 200. A partition wall hole 311 may be formed in the partition wall 310. The partition wall hole 311 may be positioned lower than the heat exchanger 130. When the water level of the pool water in the inner space S1 of the partition wall 310 reaches the partition wall hole 311 or is positioned below the partition wall hole 311 due to an increase in pressure of the inner space by the pressure control unit 400, bubbles may be generated from the partition wall hole 311.

The partition wall cover 320 may be disposed on the upper side of the partition wall 310 to cover the inner space S1 of the partition wall 310. In other words, the partition wall cover 320 may cover an upper side of the nuclear reactor 100. Furthermore, the partition wall cover 320 may be supported by the support part 210 of the pool 200 to cover the upper side of the nuclear reactor 100. Meanwhile, the partition wall cover 320 may be installed only at a location among the plurality of partition walls 310 where the water level of the pool water is to be lowered. For example, for maintenance of the heat exchanger 130 of one of the plurality of nuclear reactors 100, the partition wall cover 320 may be installed on an upper side of an inner space S1 accommodating the one nuclear reactor 100, and may not be installed on an upper side of an inner space S1 accommodating the remaining nuclear reactors 100.

The pressure control unit 400 may control a pressure of the inner space S1 of the partition unit 300. For example, the pressure control unit 400 may increase the pressure of the inner space S1 of the partition unit 300 when the nuclear reactor 100 is stopped or maintenance of the heat exchanger 130 is required. When the pressure of the inner space S1 of the partition unit 300 is increased by the pressure control unit 400, the pressure of the inner space S1 of the partition unit 300 may be higher than a pressure of an outside of the partition unit 300. Furthermore, a water level of pool water in the inner space S1 of the partition unit 300 may be lowered. In other words, the pressure control unit 400 may be configured to increase a pressure of the inner space S1 of the partition unit 300 so that a water level of the pool water inside the partition unit 300 is lowered down to a level lower than at least a portion of the heat exchanger 130. For example, the water level of the pool water in the inner space S1 of the partition unit 300 may be disposed lower than the partition wall hole 311 and the heat exchanger 130. When the water level of the pool water in the inner space S1 of the partition unit 300 is lowered by the pressure control unit 400, a water level of the pool water located outside the partition unit 300 may be maintained or increased. The pressure control unit 400 may be supported by the partition unit 300. In other words, the pressure control unit 400 may be disposed on the upper side of the partition wall cover 320.

Furthermore, the pressure control unit 400 may increase a pressure of an inner space S1 of one of the plurality of partition units 300 such that a water level of a pool water within the one partition unit 300 is lowered. In other words, when the water level of the pool water in one partition unit 300 is lowered, a water level of the pool water in another partition unit 300 may be maintained. Furthermore, when the water level of the pool water in the one partition unit 300 is lowered, the water level of the pool water in another partition unit 300 may be increased by an inflow of pool water from the one partition unit 300.

The pressure control unit 400 may adjust the pressure of the inner space S1 of the partition unit 300 to be equal to a pressure outside the partition unit 300, such that the water level of the pool water of the partition unit 300 is equal to a water level of pool water outside the partition unit 300.

Hereinafter, operations and effects of the nuclear reactor facility 1 according to the first embodiment of the present disclosure will be described.

The pressure control unit 400 of the nuclear reactor facility 1 according to the first embodiment of the present disclosure may increase the pressure of the inner space S1 of the partition unit 300 when maintenance of the heat exchanger 130 is required. As the pressure of the inner space S1 is increased by the pressure control unit 400, the water level of the pool water in the inner space S1 of the partition unit 300 may be lowered. The pressure control unit 400 may increase the pressure of the inner space S1 until bubbles are formed at the partition wall hole 311.

Since the water level of the pool water in the inner space S1 of the partition unit 300 may be lowered by the pressure control unit 400, the heat exchanger 130 may be easily maintained.

Furthermore, only the water level of the pool water in the inner space S1 of the partition unit 300 accommodating the nuclear reactor 100 requiring maintenance may be lowered, while the water level of the pool water outside the partition unit 300 accommodating the nuclear reactor 100 requiring maintenance is maintained. Accordingly, an accident response capability may be maintained for the other nuclear reactors 100 that are not under maintenance.

Furthermore, due to the partition wall hole 311, a determination as to whether the water level of the pool water in the inner space S1 of the partition unit 300 has reached a target water level may be easily made.

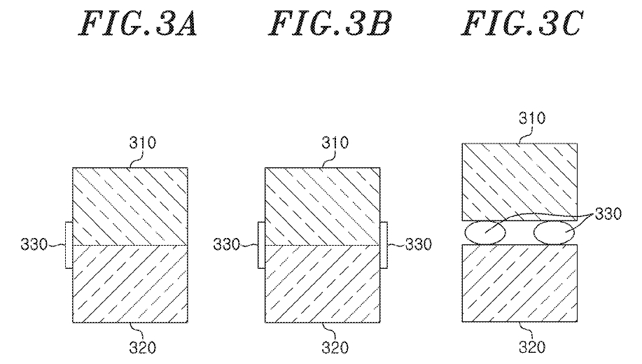

Hereinafter, a nuclear reactor facility 1 according to a second embodiment of the present disclosure will be described with reference to FIGS. 3A, 3B and 3C. In describing the second embodiment, there is a difference in that the partition unit 300 further includes a sealing unit 330, and thus this difference will be mainly described.

The sealing unit 330 may be connected to the partition wall 310 and the partition wall cover 320 to seal between the partition wall 310 and the partition wall cover 320. The sealing unit 330 may extend along an outer circumferential surface of the partition wall 310. As a first example, the sealing unit 330 may be disposed to be in contact with at least one of an outer surface and an inner surface of the partition wall 310 and the partition wall cover 320 to seal between the partition wall 310 and the partition wall cover 320, and may extend along the outer circumferential surface of the partition wall 310. As a second example, the sealing unit 330 may be disposed between the partition wall 310 and the partition wall cover 320 and extend along the upper side of the partition wall 310 to seal between the partition wall 310 and the partition wall cover 320. By the sealing unit 330 of the second example, the partition wall 310 and the partition wall cover 320 may be spaced apart from each other.

Hereinafter, operations and effects of the nuclear reactor facility 1 according to the second embodiment of the present disclosure will be described.

The sealing unit 330 may be further disposed on the partition wall 310 on which the partition wall cover 320 is installed among the plurality of partition walls 310 of the nuclear reactor facility 1 according to the second embodiment.

Since the space between the partition wall 310 and the partition wall cover 320 may be sealed by the sealing unit 330, the pressure of the inner space S1 of the partition wall 310 may be rapidly increased.

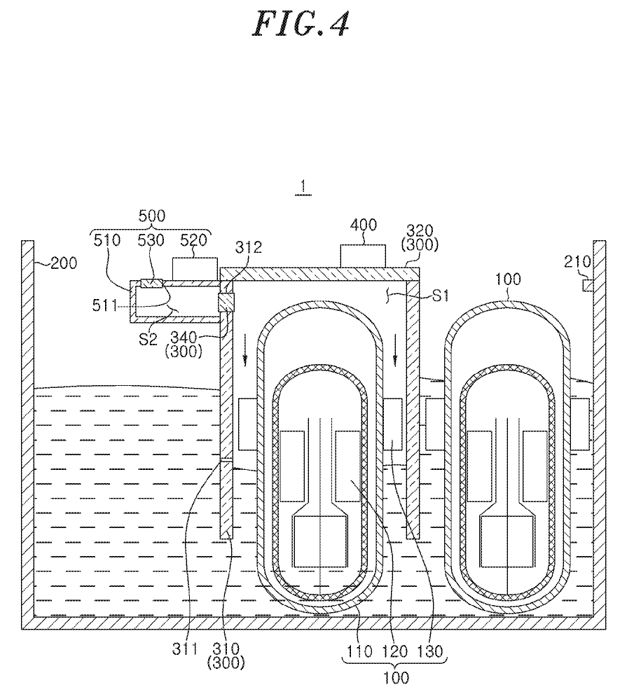

Hereinafter, a nuclear reactor facility 1 according to a third embodiment of the present disclosure will be described with reference to FIG. 4. In describing the third embodiment, there are differences in that an access device 500 is further included, the partition unit 300 further includes a partition unit door 340, and a partition wall entrance 312 may be formed in the partition wall 310, and thus these differences will be mainly described.

The partition wall entrance 312 may be formed in the partition wall 310. A user may access the inner space S1 of the partition wall 310 through the partition wall entrance 312.

The partition unit door 340 may be movably disposed relative to the partition wall 310 to open and close the partition wall entrance 312.The partition unit door 340 may be rotatable in a vertical or horizontal direction relative to the partition wall 310 to open and close the partition wall entrance 312. For example, the partition unit door 340 may be rotated by a user to access the inner space S1 of the partition wall 310. In addition, the partition unit door 340 may employ any door opening and closing mechanism known in the art in opening and closing the partition wall entrance 312.

The access device 500 may be supported by the partition unit 300 and provide an access space S2 in which a user waits before accessing the inner space S1 of the partition wall 310. For example, the access device 500 may be a conventional airlock. The access device 500 may be supported by the partition unit 300 to be disposed above the water level of the pool 200. The access device 500 may include a device body 510, an access space control unit 520, and a body door 530.

The device body 510 may be a housing providing an exterior of the access device 500. The device body 510 may be supported by the partition wall 310. The device body 510 may provide the access space S2 allowing a user to access therein. The device body 510 may be disposed on the partition wall 310 such that the access space S2 and the inner space S1 of the partition wall 310 communicate with each other when the partition unit door 340 opens the partition wall entrance 312. Furthermore, a body entrance 511 may be formed in the device body 510. A user may access the access space S2 of the device body 510 through the body entrance 511.

The access space control unit 520 may control the pressure of the access space S2 of the device body 510. The access space control unit 520 may increase the pressure of the access space S2 of the device body 510 such that the pressure of the access space S2 of the device body 510 is equal to the pressure of the inner space S1 of the partition unit 300. Furthermore, the access space control unit 520 may decrease the pressure of the access space S2 of the device body 510 such that the pressure of the access space S2 of the device body 510 is equal to the pressure of the external space of the partition unit 300. The access space control unit 520 may be disposed outside the device body 510.

The body door 530 may be movably disposed relative to the device body 510 to open and close the body entrance 511. The body door 530 may be rotatable in a vertical direction relative to the device body 510 to open and close the body entrance 511. For example, the body door 530 may be rotated by a user to access the inner space S1 of the partition wall 310. In addition, the body door 530 may employ any door opening and closing mechanism known in the art in opening and closing the body entrance 511.

Hereinafter, operations and effects of the nuclear reactor facility 1 according to the third embodiment of the present disclosure will be described.

According to the third embodiment of the present disclosure, after the pressure of the inner space S1 of the partition unit 300 is increased by the pressure control unit 400 of the nuclear reactor facility 1, the access space control unit 520 may increase the pressure of the access space S2 of the device body 510. A user may enter the access space S2 of the device body 510 through the body entrance 511 and then close the body entrance 511 using the body door 530 before the pressure of the access space S2 of the device body 510 is increased by the access space control unit 520.When the pressure of the access space S2 of the device body 510 becomes equal to the pressure of the inner space S1 of the partition unit 300, the user may open the partition wall entrance 312 using the partition unit door 340 and access the inner space S1 of the partition wall 310 for maintenance of the nuclear reactor 100.

The access device 500 allows a user to access the inner space S1 even when the pressures inside and outside the partition unit 300 are different.

Furthermore, even when the partition wall entrance 312 is opened, pressurized state of the inner space S1 of the partition unit 300 may be maintained by the access device 500.

Furthermore, after the maintenance operation is completed, the user may exit to the outside of the partition unit 300 again by performing the entry procedure into the inner space in reverse order.

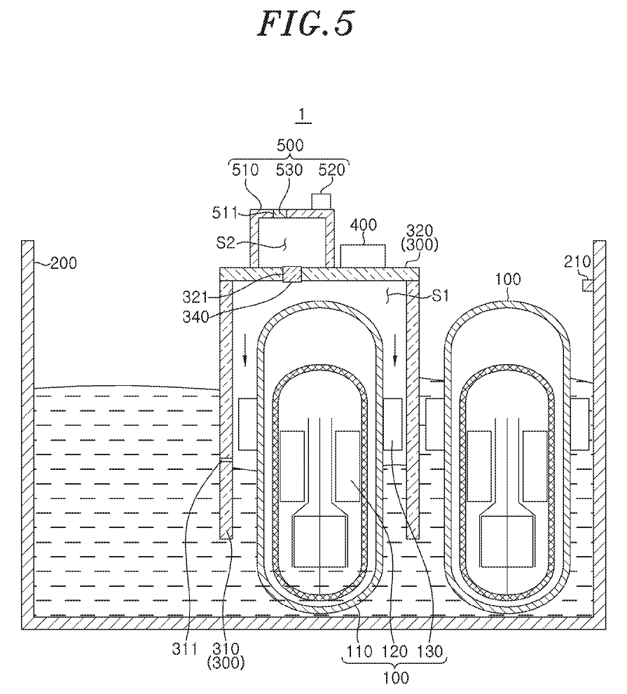

Hereinafter, a nuclear reactor facility 1 according to a fourth embodiment of the present disclosure will be described with reference to FIG. 5. In describing the fourth embodiment, there is a difference in that a cover entrance 321 is formed in the partition wall cover 320, and thus this difference will be mainly described.

The cover entrance 321 may be provided in the partition wall cover 320. A user may access the inner space S1 through the cover entrance 321.

The partition unit door 340 may be movably disposed relative to the partition wall cover 320 to open and close the cover entrance 321. The partition unit door 340 may be rotatable in a vertical or horizontal direction relative to the partition wall cover 320 to open and close the cover entrance 321. For example, the partition unit door 340 may be rotated by a user to access the inner space S1. In addition, the partition unit door 340 may employ any door opening and closing mechanism known in the art in opening and closing the partition wall cover 320.

The device body 510 may be connected to the upper side of the partition wall cover 320 and supported by the partition wall cover 320. The device body 510 may be disposed on the partition unit door 340 such that the access space S2 communicates with the inner space S1 when the partition unit door 340 opens the cover entrance 321.

Hereinafter, operations and effects of the nuclear reactor facility 1 according to the fourth embodiment of the present disclosure will be described.

According to the fourth embodiment of the present disclosure, after the pressure of the inner space S1 of the partition unit 300 is increased by the pressure control unit 400 of the nuclear reactor facility 1, the access space control unit 520 may increase the pressure of the access space S2 of the device body 510 A user may enter the access space S2 of the device body 510 through the body entrance 511 and then close the body entrance 511 using the body door 530 before the pressure of the access space S2 of the device body 510 is increased by the access space control unit 520. When the pressure of the access space S2 of the device body 510 becomes equal to the pressure of the inner space S1, the user may open the cover entrance 321 using the partition unit door 340 and move to the inner space S1 for maintenance of the nuclear reactor 100.

The user may easily move to the inner space S1 by opening the cover entrance 321 using the partition unit door 340.

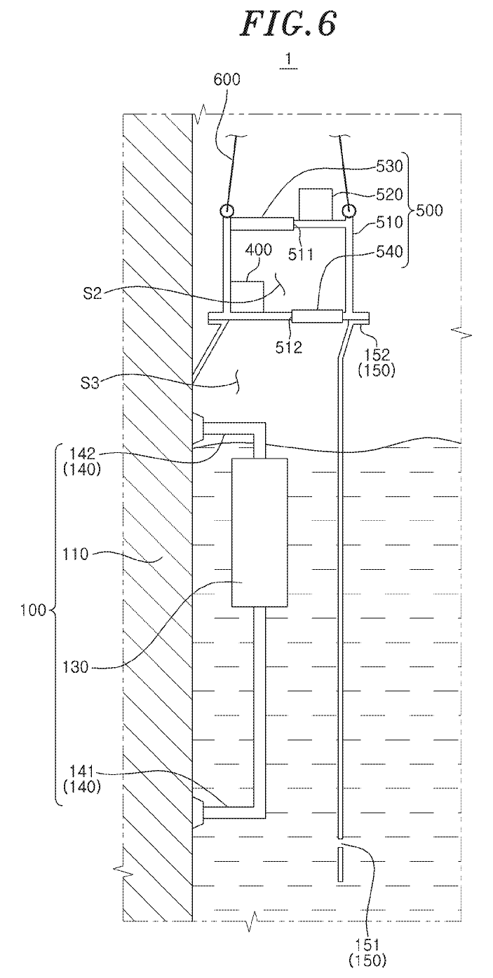

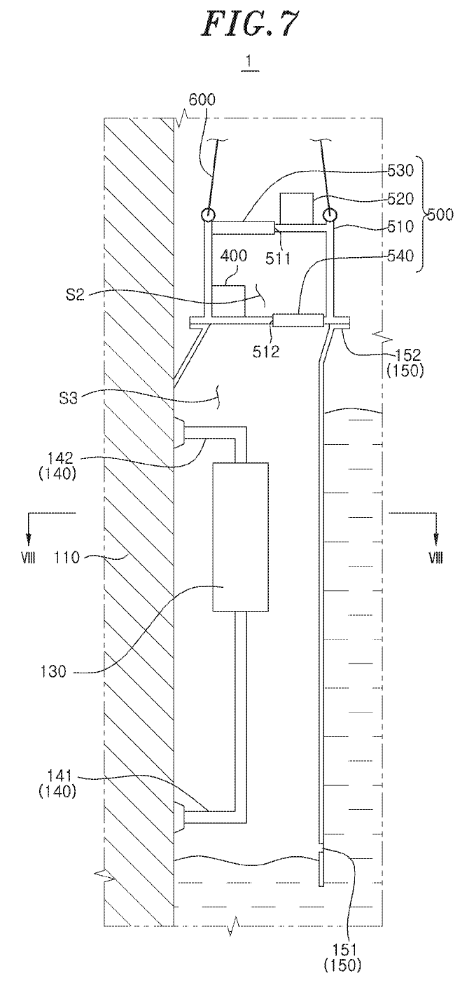

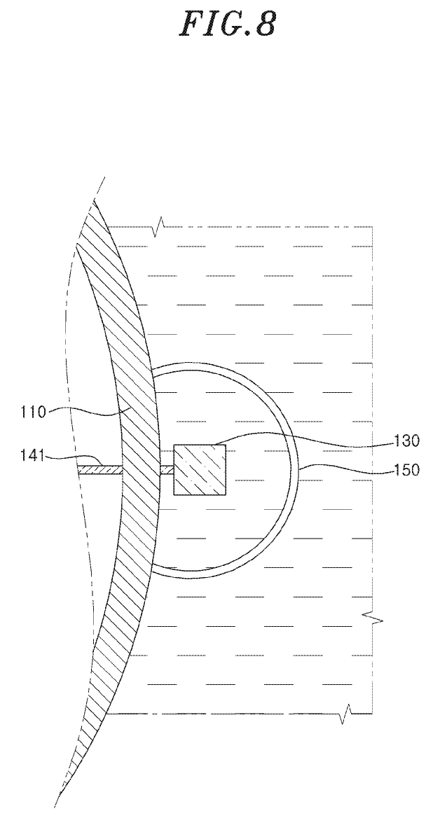

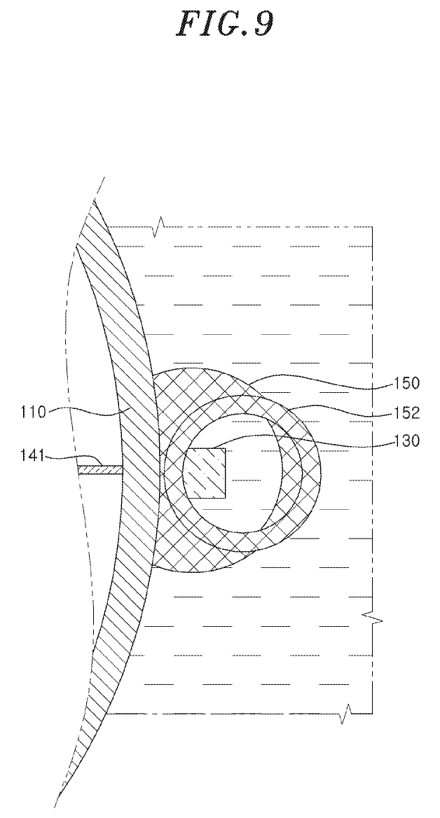

Hereinafter, a nuclear reactor facility 1 according to a fifth embodiment of the present disclosure will be described with reference to FIGS. 6 through 9. In describing the fifth embodiment, there are differences in that a transfer unit 600 is further included, the nuclear reactor 100 further includes a piping unit 140 and an accommodating part 150, and the access device 500 further includes an accommodating part door 540, and thus these differences will be mainly described.

The piping unit 140 of the nuclear reactor 100 may be connected to the heat exchanger 130 and the steam generator 120 to provide a flow path for steam and cooling water. The piping unit 140 may include a first piping unit 141 and a second piping unit 142.

The first piping unit 141 may provide a flow path through which cooling water discharged from the heat exchanger 130 flows to the steam generator 120. The second piping unit 142 may provide a flow path through which steam flows so that steam generated from the steam generator 120 flows to the heat exchanger 130. The first piping unit 141 may be disposed lower than the second piping unit 142.

The accommodating part 150 may be disposed outside the pressure vessel 110 to provide an accommodation space S3 accommodating the heat exchanger 130 and the piping unit 140. Openings may be formed at a lower side and an upper side of the accommodating part 150. Furthermore, the lower side of the accommodating part 150 may be spaced apart from the bottom surface of the pool 200 and an opening may be formed. By the accommodating part 150, the pool water may be introduced into the accommodation space S3 of the accommodating part 150. A water level of the pool water in the accommodation space S3 may be equal to the water level of the pool water disposed outside the accommodating part 150. When a pressure of the accommodation space S3 is increased, the water level of the pool water in the accommodation space S3 may be lower than the water level of the pool water outside the accommodating part 150.

A through-hole 151 may be formed in the accommodating part 150. The through-hole 151 may be disposed lower than the piping unit 140 or the heat exchanger 130. For example, the through-hole 151 may be disposed lower than at least a portion of the piping unit 140 or at least a portion of the heat exchanger 130. When the water level of the pool water in the accommodation space S3 reaches or falls below the through-hole 151, bubbles may be generated from the through-hole 151. Furthermore, a flange 152 on which the device body 510 may be seated may be provided on the upper side of the accommodating part 150. The flange 152 may be spaced apart from the pressure vessel 110.

The pressure control unit 400 may be disposed in the access space S2 of the device body 510. The pressure control unit 400 may control the pressure of the accommodation space S3 of the accommodating part 150. In other words, the pressure control unit 400 may increase the pressure of the accommodation space S3 such that the water level of the pool water in the accommodation space S3 of the accommodating part 150 becomes lower than the through-hole 151. When the water level of the pool water in the accommodation space S3 is lowered, the water level of the pool water outside the accommodating part 150 may be maintained or increased.

An accommodating part entrance 512 may be formed in the device body 510 to allow a user to access the accommodation space S3 of the accommodating part 150. The access space control unit 520 may be disposed on an upper side of the device body 510. Furthermore, a body entrance 511 connecting the access space S2 of the device body 510 and the external space of the device body 510 may be provided at one side of the device body 510. The body door 530 may be disposed at the body entrance 511. For example, the device body 510 may be an airlock.

The access space control unit 520 may increase the pressure of the access space S2 of the device body 510 such that the pressure is equal to the pressure of the accommodation space S3 of the accommodating part 150. Furthermore, the access space control unit 520 may decrease the pressure of the access space S2 of the device body 510 such that the pressure is equal to the pressure of external space of the device body 510.

The accommodating part door 540 may be movably disposed relative to the device body 510 to open and close the accommodating part entrance 512. In other words, the accommodating part door 540 may be rotatable in a vertical direction relative to the device body 510 to open and close the accommodating part entrance 512. In other words, a user may open the accommodating part entrance 512 by rotating the accommodating part door 540 to move to the accommodation space S3 of the accommodating part 150. In addition, the accommodating part door 540 may employ any door opening and closing mechanism known in the art in opening and closing the accommodating part entrance 512.

The transfer unit 600 may transfer the access device 500. The transfer unit 600 may transfer the access device 500 such that the access device 500 is disposed on the upper side of the accommodating part 150 or the access device 500 is spaced apart from the accommodating part 150. For example, the transfer unit 600 may be a crane including a wire or the like.

Hereinafter, operations and effects of the nuclear reactor facility 1 according to the fifth embodiment of the present disclosure will be described.

The transfer unit 600 of the nuclear reactor facility 1 according to the fifth embodiment of the present disclosure may transfer the access device 500 to be seated on the flange 152 of the accommodating part 150 when at least one of the heat exchanger 130 and the piping unit 140 requires maintenance. When the access device 500 is seated on the flange 152, the pressure of the accommodation space S3 of the accommodating part 150 may be increased by the pressure control unit 400. The pressure control unit 400 may increase the pressure of the accommodation space S3 until bubbles are formed at the through-hole 151. Meanwhile, independently of increasing the pressure of the accommodation space S3, a user may first enter the access space S2 through the body entrance 511 after opening the body door 530 in preparation for entry into the accommodation space S3. After entering the access space S2, the user may close the body door 530 and increase the pressure of the access space S2 by the access space control unit 520 such that the pressure of the access space S2 becomes equal to the pressure of the accommodation space S3 while the accommodating part door 540 remains closed. When the water level of the accommodation space S3 is lowered to a target level such that bubbles are generated from the through-hole 151 and the pressure of the access space S2 is equal to the pressure of the accommodation space S3, the user may open the accommodating part entrance 512 through the accommodating part door 540 and access the accommodation space S3.

Since only the water level of the pool water of the accommodating part 150 of the nuclear reactor 100 requiring maintenance is lowered, the nuclear reactor facility 1 may maintain accident response capability for the remaining nuclear reactors 100.

Furthermore, since the water level of the pool water may be lowered, inspection and maintenance of the heat exchanger 130, the piping unit 140 and a penetrating portion of the pressure vessel 110 penetrated by the piping unit 140 may be facilitated.

Although the embodiments of the present disclosure have been described as specific exemplary embodiments, these are merely exemplary, and the present disclosure is not limited thereto, and should be construed as having the broadest scope following the technical spirit disclosed in the present specification. A person skilled in the art may implement a pattern of an unspecified shape by combining/substituting the disclosed exemplary embodiments, but this also does not depart from the scope of the present disclosure. In addition, a person skilled in the art may easily change or modify the disclosed exemplary embodiments based on the present specification, and such changes or modifications obviously also fall within the scope of the present disclosure.

DESCRIPTION OF THE SYMBOLS
1: nuclear reactor facility
100: nuclear reactor
110: pressure vessel
120: steam generator
130: heat exchanger
140: piping unit
141: first piping unit
142: second piping unit
150: accommodating part
151: through-hole
152: flange
200: pool
210: support part
300: partition unit
310: partition wall
311: partition wall hole
312: partition wall entrance
320: partition wall cover
321: cover entrance
340: partition unit door
400: pressure control unit
500: access device
510: device body
511: body entrance
512: accommodating part entrance
520: access space control unit
530: body door
540: accommodating part door
600: transfer unit

What is claimed is:

1. A nuclear reactor facility, comprising:
a pressure vessel;
a pool providing pool water in which the pressure vessel is submerged;
a partition unit disposed inside the pool to provide an inner space in which the pressure vessel is accommodated;
a heat exchanger disposed in the inner space of the partition unit and outside the pressure vessel to transfer heat from the pressure vessel to the pool water of the pool; and
a pressure control unit configured to increase a pressure of the inner space of the partition unit so that a water level of the pool water inside the partition unit is lowered down to a level lower than at least a portion of the heat exchanger.

2. The nuclear reactor facility of claim 1, wherein when the pressure inside the partition unit is increased by the pressure control unit, a water level of the pool water outside the partition unit is maintained.

3. The nuclear reactor facility of claim 1, wherein a partition wall hole is formed in the partition unit, the partition wall hole is disposed lower than the heat exchanger, and the pressure control unit increases the pressure inside the partition unit so that the water level of the pool water in the inner space becomes lower than the partition wall hole.

4. The nuclear reactor facility of claim 1, wherein a lower end of the partition unit is spaced apart from a bottom surface of the pool.

5. The nuclear reactor facility of claim 1, wherein the partition unit comprises:
a partition wall providing the inner space; and
a partition wall cover disposed on an upper side of the partition wall to cover the inner space.

6. The nuclear reactor facility of claim 5, wherein the partition unit further comprises a sealing unit disposed between the partition wall cover and the partition wall to seal an interface between the partition wall cover and the partition wall.

7. The nuclear reactor facility of claim 1, further comprising an access device supported by the partition unit,
wherein the access device comprises:
a device body supported by the partition unit to provide an access space; and
an access space control unit to regulate a pressure of the access space of the device body,
wherein the access space control unit increases the pressure of the access space of the device body so that the pressure of the inner space of the partition unit and the pressure of the access space of the device body become equal to each other, or decreases the pressure of the access space of the device body so that a pressure of an external space of the partition unit and the pressure of the access space of the device body become equal to each other.

8. The nuclear reactor facility of claim 7, wherein the partition unit comprises:
a partition wall providing the inner space, and having a partition wall entrance formed to allow access to the inner space; and
a partition unit door movably disposed relative to the partition wall to open and close the partition wall entrance.

9. The nuclear reactor facility of claim 8, wherein the device body is supported by the partition wall such that, when the partition unit door opens the partition wall entrance, the inner space and the access space communicate with each other,
wherein a body entrance is formed in the device body, and
wherein the access device further comprises a body door movably disposed relative to the device body to open and close the body entrance.

10. The nuclear reactor facility of claim 7, wherein the partition unit comprises:
a partition wall providing the inner space;
a partition wall cover supported by the partition wall to cover an upper side of the inner space, and the partition wall cover having a cover entrance formed to allow access to the inner space; and
a partition unit door movably disposed relative to the partition wall cover to open and close the cover entrance.

11. The nuclear reactor facility of claim 10, wherein the device body is supported by the partition wall cover such that when the partition unit door opens the cover entrance, the inner space and the access space communicate with each other,
wherein a body entrance is formed in the device body, and
wherein the access device further comprises a body door movably disposed relative to the device body to open and close the body entrance.

12. A nuclear reactor facility, comprising:
a pressure vessel;
a pool providing pool water in which the pressure vessel is submerged;
a heat exchanger disposed outside the pressure vessel to transfer heat from the pressure vessel to the pool water of the pool;
an accommodating part supported outside the pressure vessel and providing an accommodation space in which the heat exchanger is accommodated; and
a pressure control unit configured to increase a pressure of the accommodation space of the accommodating part so that a water level of the pool water inside the accommodating part is lowered down to a level lower than at least a portion of the heat exchanger,

13. The nuclear reactor facility of claim 12, further comprising:
a steam generator disposed inside the pressure vessel to generate steam by heat of the pressure vessel; and
a piping unit connected to the steam generator and the heat exchanger, and providing a passage through which steam generated from the steam generator flows to the heat exchanger to be cooled by cooling water in the heat exchanger, or providing a passage through which cooling water discharged from the heat exchanger flows to the steam generator,
wherein the pressure control unit increases the pressure of the accommodation space of the accommodating part such that the water level of the pool water in the accommodation space becomes lower than at least a portion of the piping unit.

14. The nuclear reactor facility of claim 13, wherein a through-hole is formed in the accommodating part, and the through-hole is disposed lower than at least a portion of the piping unit.

15. The nuclear reactor facility of claim 12, wherein openings are formed at an upper side and a lower side of the accommodating part, and the lower side of the accommodating part is spaced apart from a bottom surface of the pool.

16. The nuclear reactor facility of claim 12, further comprising:
an access device supporting the pressure control unit; and
a transfer unit transferring the access device such that the access device is disposed on an upper side of the accommodating part, or the access device is spaced apart from the accommodating part.

17. The nuclear reactor facility of claim 16, wherein a flange is provided on an upper side of the accommodating part to support the access device.

18. The nuclear reactor facility of claim 16, wherein the access device further comprises:
a device body transferred by the transfer unit and disposed on an upper side of the accommodating part to cover the accommodation space of the accommodating part, the device body providing an access space therein; and
an access space control unit supported by the device body to regulate a pressure of the access space of the device body.

19. The nuclear reactor facility of claim 18, wherein the device body further comprises:
a body entrance for a user to access to the access space of the device body; and
an accommodating part entrance for a user to access to the accommodation space of the accommodating part, and
wherein the access device further comprises:
a body door movably disposed relative to the device body to open and close the body entrance; and
an accommodating part door movably disposed relative to the device body to open and close the accommodating part entrance.

20. The nuclear reactor facility of claim 18, wherein the access space control unit increases the pressure of the access space of the device body such that the pressure of the access space becomes equal to the pressure of the accommodation space of the accommodating part, or decreases the pressure of the access space of the device body such that the pressure of the access space becomes equal to a pressure of a space outside the device body.
